(19) United States
(12) Patent Application Publication
(10) Pub. No.: US 2017/0127859 A1
(43) Pub. Date: May 11, 2017

(54) MULTIPLE TRAVELER WATER BOTTLE

(71) Applicant: Doskocil Manufacturing Company, Inc., Arlington, TX (US)

(72) Inventors: Christopher James HORNUNG, Watersmeet, MI (US); Zeng Yi BAO, Zhongshan (CN); Tianle YANG, Zhongshan (CN)

(21) Appl. No.: 15/067,768

(22) Filed: Mar. 11, 2016

(30) Foreign Application Priority Data
Nov. 10, 2015 (CN) 201520893168

(51) Int. Cl. A47G 19/22; B65D 55/16; A01K 7/00; B65D 1/02

(52) U.S. Cl. CPC A47G 19/2266; B65D 1/0246; B65D 1/0284; B65D 55/16; A01K 7/00

(57) ABSTRACT

A portable dual-use water bottle, includes an upper cap, a bottle body, and a lower bottom. The bottle body has a lower portion and a lower bottom. The lower bottom cap has a volume, the lower bottom cap being soft, and firmly buckled to the lower portion of the bottle body by the lower bottom of the bottle body and firmly sleeved and fixed thereto.

### CROSS-REFERENCE TO RELATED APPLICATIONS

This application claims priority to Chinese Application No. 201520893168, filed Nov. 10, 2015, the contents of which is hereby incorporated herein by reference.

### BACKGROUND

Field of Invention

The present invention relates to the field of daily necessities, in particular to a water bottle for both pets and the pet owners or for both adults and children.

Background of the Invention

With the improvement of people's living standards, keeping pets has increasingly become a choice of many families and persons. Furthermore, as time goes on, the way of keeping pets changes. Pets are often not left at home any more. Instead, they live and go everywhere with their owners just like friends.

In this case, carrying a water bottle for pets and another water bottle for the owner, since pets need a large amount of water when going out in summer, is cumbersome, easy to leave the water bottles behind and inconvenient to operate them.

Additionally, it is also cumbersome to carry two water bottles when adults go out with children.

### SUMMARY

In view of what descried in the background, it is necessary to provide a dual-use water bottle which is convenient to use and carry and the dual use of which will not cause pollution.

An objective of the present invention is realized by the following technical solutions.

A portable dual-use water bottle is provided, including an upper cap, a bottle body and a lower bottom cap having a volume; the lower bottom cap being soft, and being buckled to the lower portion of the bottle body by the lower bottom of the bottle body and firmly sleeved and fixed thereto.

The upper cap includes an upper cap body having a volume and a cap belt; the upper cap body covers an opening of the bottle body in a detachable manner; one end of the cap belt is fixedly connected to the upper cap body and the other end thereof is connected to the bottle body; and an inner surface of the lower bottom cap and an outer surface of the lower portion of the bottle body are firmly sleeved and fixed to each other; or, a plurality of convex ribs is disposed on the outer surface of the lower portion of the bottle body, a plurality of corresponding concave grooves is disposed on the inner surface of the lower bottom cap, and the lower portion of the bottle body and the lower bottom cap are sleeved and fixed to each other by buckling the convex ribs to the concave grooves.

Preferably, the radial dimension of the lower portion of the bottle body is greater than that of an upper portion of the bottle body.

Preferably, one side of the lower bottom cap is high while the other opposite side is low.

Preferably, an edge of the opening of the lower bottom cap is a smooth arc.

Preferably, an upper end and a lower end of the lower portion, matched with the lower bottom cap, of the bottle body have a small radial dimension, while the middle part thereof has a large radial dimension.

Preferably, a plurality of concave grooves, used for enhancing the friction and ventilation, is arranged in the periphery of the outer surface of the lower portion of the bottle body.

Preferably, antiskid strips, used for enhancing the friction and preventing the bottle from falling down, are provided on the outer surface of the lower bottom cap.

Preferably, the upper cap body is screwed to an upper opening of the bottle body by threads.

Preferably, one end of the cap belt is a small ring while the other end thereof is a big ring; the small ring is fixedly mounted on the upper surface of the upper cap body; and a retaining ring is provided at the opening of the bottle body, and the big ring is sleeved in the retaining ring.

Optionally, a concave groove is arranged on the upper surface of the upper cap body, and the small ring is buckled in the concave groove by a belt buckle and fixed thereto.

Compared with the prior art, the present invention has the following advantages.
1. The entire bottle body has a big upper portion and a small lower portion, and is quite stable when placed well.
2. The lower bottom cap and the lower portion of the bottle body are fixedly joined to each other by friction, or, convex ribs are arranged in the lower portion of the bottle body, and corresponding concave grooves are arranged on the lower bottom cap, so that it is more convenient to join and separate the bottle body to and from the lower bottom cap.
3. The lower bottom cap is made of soft material so that the join of the lower bottom cap to the lower portion of the bottle body by friction is more stable; furthermore, the lower bottom cap is light weight and gives a comfortable sense in holding, and meanwhile can serve as a guard for the bottle body;
4. The lower portion of the bottle body has two small ends and a big middle part, so that the lower portion of the bottle body may be joined to the lower bottom cap more stably, and a user will feel more comfortable in holding.
5. The lower bottom cap has a high side for ease of holding and a low side for drinking water, and in this way, it is more convenient when in use.

### BRIEF DESCRIPTION OF THE DRAWINGS

The invention will be explained in more detail hereinafter with reference to the drawings.

FIG. 1 is an exploded view of an embodiment of the present invention; and

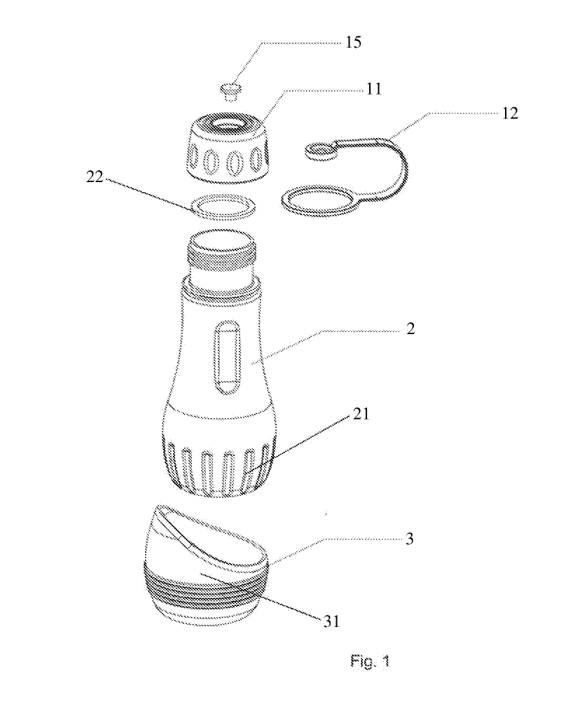

FIG. 2 is a schematic diagram of an overall structure according to the embodiment of the present invention.

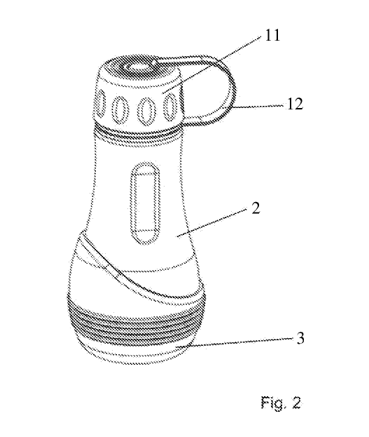

### DETAILED DESCRIPTION OF THE EMBODIMENTS

In this embodiment, a portable dual-use water bottle is provided, including an upper cap 1, a bottle body 2 and a lower bottom cap 3 having a volume.

The upper cap includes an upper cap body 11 having a volume and a cap belt 12; the upper cap body 11 covers an opening of the bottle body by threads; and one end of the cap belt 12 is fixedly connected to the top of the upper cap body 11 and the other end thereof is connected to the bottle body 2.

The lower bottom cap 3 is made of soft material, for example, silica gel or TPR, and is buckled to the lower portion of the bottle body 1 by the lower bottom of the bottle body 1; and an inner surface of the lower bottom cap 3 and an outer surface of the lower portion of the bottle body 2 are coordinated with each other by friction, and firmly sleeved and fixed thereto. The radial dimension of the lower portion of the bottle body 2 is greater than that of an upper portion of the bottle body. One side of the lower bottom cap 3 is high while the other opposite side is low, and an edge of the opening of the lower bottom cap is a smooth arc. An upper end and a lower end of the lower portion of the bottle body have a small radial dimension, while the middle part thereof has a large radial dimension. The lower portion of the bottle body is shaped like a spindle. A plurality of concave grooves 21, used for enhancing the friction and ventilation, is further arranged in the periphery of the outer surface of the lower portion of the bottle body. Antiskid strips 31 are further provided on the outer surface of the lower bottom cap 3.

One end of the cap belt 12 is a small ring while the other end thereof is a big ring; the small ring is fixedly mounted on a top surface of the upper cap body 11 and fixed by a cap belt buckle 15; and a retaining ring 22 is disposed at the opening of the bottle body 2, and the big ring is sleeved in the retaining ring 22.

The technical solutions to be protected by the present invention are not limited to the aforementioned embodiment, other variations may be possible. For example, a plurality of convex ribs may be arranged in the periphery of the outer surface of the lower portion of the bottle body, a plurality of corresponding concave grooves may be arranged on the inner surface of the lower bottom cap, and the lower portion of the bottle body and the lower bottom cap are sleeved and foxed to each other by buckling the convex ribs to the concave grooves. For another example, the upper end of the lower bottom cap may be flat, and have a same circumferential height; and the edge of the opening of the lower bottom cap is not limited to be a smooth arc, and instead, it may be wavy or in other shapes.

It should be noted that, for a person of ordinary skill in the art, a number of variations and improvements may be made without departing from the concept of the present invention, and those variations and improvements should be regarded as falling into the protection scope of the present invention. Therefore, the protection scope of the utility model should be subject to the appended claims.

1. A portable dual-use water bottle, comprising:
an upper cap;
a bottle body having a lower portion and a lower bottom; and
a lower bottom cap having a volume,
the lower bottom cap being soft, and firmly buckled to the lower portion of the bottle body by the lower bottom of the bottle body and firmly sleeved and fixed thereto.

2. The portable dual-use water bottle according to claim 1, wherein
an inner surface of the lower bottom cap and an outer surface of the lower portion of the bottle body are firmly sleeved and fixed to each other by friction.

3. The portable dual-use water bottle according to claim 1, wherein
an outer surface of the lower portion of the bottle body includes a plurality of convex ribs, the inner surface of the lower bottom cap includes a plurality of concave grooves corresponding to the plurality of convex ribs, and the lower portion of the bottle body and the lower bottom cap are sleeved and fixed to each other by buckling the convex ribs to the concave grooves.

4. The portable dual-use water bottle according to claim 1, wherein
a radial dimension of the lower portion of the bottle body is greater than a radial dimension of an upper portion of the bottle body.

5. The portable dual-use water bottle according to claim 1, wherein
one side of the lower bottom cap is higher than an opposite side.

6. The portable dual-use water bottle according to claim 1, wherein
a middle part of the lower portion of the bottle body has a larger radial dimension than a radial dimension of each of an upper end and a lower end of the lower portion of the bottle body.

7. The portable dual-use water bottle according to claim 1, wherein
a periphery of an outer surface of the lower portion of the bottle body includes a plurality of concave grooves configured to enhance friction and ventilation.

8. The portable dual-use water bottle according to claim 1, wherein
the lower bottom cap includes an outer surface, and antiskid strips are disposed on the outer surface of the lower bottom cap.

9. The portable dual-use water bottle according to claim 1, wherein
the upper cap includes an upper cap body having a volume and a cap belt, the upper cap body detachably covering an opening of the bottle body, and a first end of the cap belt is fixedly connected to the upper cap body and a second end of the cap belt is connected to the bottle body.

10. The portable dual-use water bottle according to claim 9, wherein
the first end of the cap belt is a first ring and the second end of the cap belt is a second ring, the second ring being larger than the first ring, the first ring is fixedly mounted on an upper surface of the upper cap body, and a retaining ring is disposed at the opening of the bottle body, and the second ring is sleeved in the retaining ring.

11. The portable dual-use water bottle according to claim 2, wherein
a radial dimension of the lower portion of the bottle body is greater than a radial dimension of an upper portion of the bottle body.

12. The portable dual-use water bottle according to claim 3, wherein
a radial dimension of the lower portion of the bottle body is greater than a radial dimension of an upper portion of the bottle body.

13. The portable dual-use water bottle according to claim 2, wherein
one side of the lower bottom cap is higher than an opposite side.

14. The portable dual-use water bottle according to claim 3, wherein
one side of the lower bottom cap is higher than an opposite side.

15. The portable dual-use water bottle according to claim 4, wherein
one side of the lower bottom cap is higher than an opposite side.

16. The portable dual-use water bottle according to claim 2, wherein
a middle part of the lower portion of the bottle body has a larger radial dimension than a radial dimension of each of an upper end and a lower end of the lower portion of the bottle body.

17. The portable dual-use water bottle according to claim 3, wherein
a middle part of the lower portion of the bottle body has a larger radial dimension than a radial dimension of each of an upper end and a lower end of the lower portion of the bottle body.

18. The portable dual-use water bottle according to claim 4, wherein
the radial dimension of the lower portion of the bottle body is the radial dimension of a middle part of the lower portion of the bottle body, and the radial dimension of the middle part is larger than a radial dimension of each of an upper end and a lower end of the lower portion of the bottle body.

19. The portable dual-use water bottle according to claim 2, wherein
a periphery of the outer surface of the lower portion of the bottle body includes a plurality of concave grooves configured to enhance friction and ventilation.
